(19) United States
(12) Patent Application Publication
(10) Pub. No.: US 2021/0319798 A1
(43) Pub. Date: Oct. 14, 2021

(54) CONVERSATION-BASED REPORT GENERATION WITH REPORT CONTEXT

(71) Applicant: HEWLETT-PACKARD DEVELOPMENT COMPANY, L.P., Spring, TX (US)

(72) Inventor: Rafael Dal Zotto, Porto Alegre (BR)

(73) Assignee: HEWLETT-PACKARD DEVELOPMENT COMPANY, L.P., Spring, TX (US)

(21) Appl. No.: 17/262,281

(22) PCT Filed: Nov. 1, 2018
(86) PCT No.: PCT/US2018/058688

§ 371 Date: Jan. 22, 2021

(51) Int. Cl. G10L 15/26; G06F 21/32; G10L 15/18; G10L 15/22; G06F 16/335

(52) U.S. Cl. CPC G10L 15/26; G06F 21/32; G06F 16/335; G10L 15/1815; G10L 15/22; G10L 15/1822

(57) ABSTRACT

Examples for conversation-based report generation are described herein. In some examples, a report context based on user input to a conversation manager is received. A report is generated based on the report context. The report context is saved for subsequent report generation. The report context may include information related to the intent of the user input.

### BACKGROUND

Computers are used to perform a variety of tasks, including work activities, banking, research, and entertainment. Networking technology may enable computers to communicate. For example, computers may send and/or receive information via a network. In this way, information may be shared and/or communicated between computers.

### BRIEF DESCRIPTION OF THE DRAWINGS

Various examples will be described below by referring to the following figures.

FIG. 1 is an example block diagram of a system in which conversation-based report generation with report context may be performed;

FIG. 2 is an example flow diagram illustrating a method for conversation-based report generation with report context;

FIG. 3 is another example block diagram of a system in which conversation-based report generation with report context may be performed;

FIG. 4 is an example flow diagram illustrating another method for conversation-based report generation with report context;

FIG. 5 is an example of a graphical user interface (GUI) for conversation-based report generation with report context; and

FIG. 6 is an example of a conversation manager interface for conversation-based report generation with report context.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Examples of speech-activated features to create, filter and adjust reports are described herein. The described conversation-based report generation with report context may allow users to customize the produced output from a conversation manager. Companies from all business areas produce data, generate information and are increasing the consumption of the produced information.

The described conversation-based report generation with report context may use a set of conversational structures establishing a flexible, adaptive and extensible set of scripts, based on natural language processing. The system may ask questions and clarifications to obtain a report context that enables the system to refine and define what is actually requested by the user. Further, the system may engage in the process of obtaining information from conversational interaction, local resources (e.g., a user's computer), from local software (e.g., an e-mail program and/or document folders) or remotely from other sources (a particular database or third party Application Programming Interface (API) (for online services, for example)).

The system may facilitate the access of information in an easy and quick manner to reduce the amount of time spent on manual and repetitive tasks. In some examples, the system may verify the speech of the requester (e.g., user) to ensure a trustable source and to target information that is classified and protected to restrict (e.g., limit) the access.

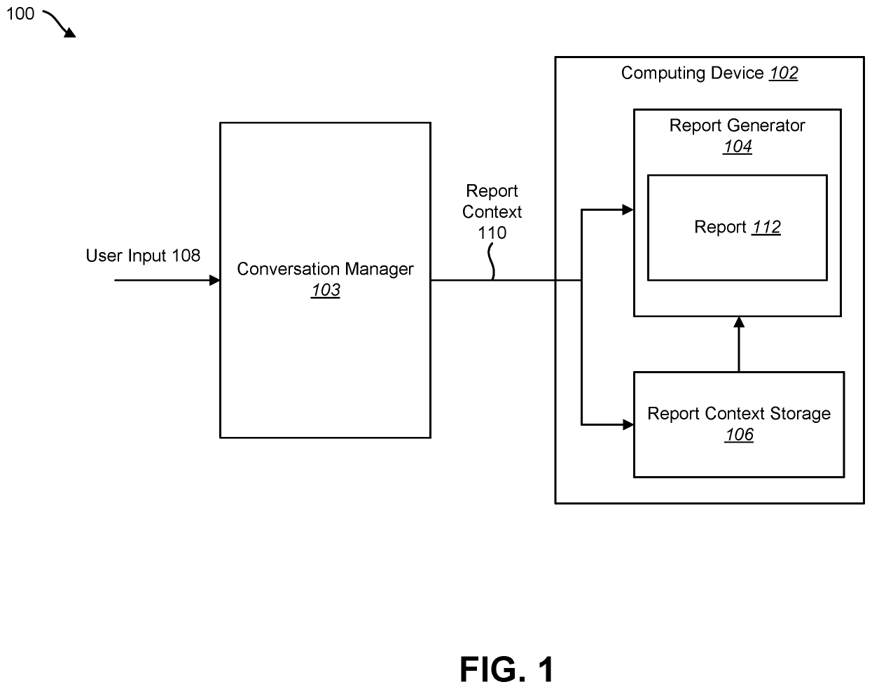

FIG. 1 is an example block diagram of a system 100 in which conversation-based report generation with report context may be performed. The system 100 may include a computing device 102. Examples of computing devices 102 may include desktop computers, laptop computers, tablet devices, smart phones, cellular phones, game consoles, server devices, and/or smart appliances, etc.). In other examples, the computing device 102 may be a distributed set of devices. For example, the computing device 102 may include multiple discrete devices organized in a system to implement the processes described herein. In some implementations, the computing device 102 may include and/or be coupled to a display for presenting information (e.g., images, text, graphical user interfaces (GUIs), etc.).

The computing device 102 may include a processor. The processor may be any of a central processing unit (CPU), a microcontroller unit (MCU), a semiconductor-based microprocessor, GPU, FPGA, an application-specific integrated circuit (ASIC), and/or other hardware devices suitable for retrieval and execution of instructions stored in the memory. The processor may fetch, decode, and execute instructions, stored on the memory and/or data storage, to implement printing device functionality based on consumption and payment.

The memory may include read only memory (ROM) and/or random access memory (RAM). The memory and the data storage may also be referred to as a machine-readable storage medium. A machine-readable storage medium may be any electronic, magnetic, optical, or other physical storage device that contains or stores executable instructions. Thus, the machine-readable storage medium may be, for example, RAM, EEPROM, a storage device, an optical disc, and the like. In some examples, the machine-readable storage medium may be a non-transitory machine-readable storage medium, where the term “non-transitory” does not encompass transitory propagating signals. The machine-readable storage medium may be encoded with instructions that are executable by the processor.

The computing device 102 may enable functionality for conversation-based report generation with report context 110. For example, the computing device 102 may include hardware (e.g., circuitry and/or processor(s), etc.) and/or machine-executable instructions (e.g., program(s), code, and/or application(s), etc.) for communicating with a conversation manager 103. The computing device 102 may generate a report 112 based on a report context 110 received from the conversation manager 103.

A conversation manager 103 may include a computer program that receives user input 108 in the form of human language and determines a report context 110 based on the user input 108. In some examples, the user input 108 may be in the form of speech-based communication (e.g., spoken words and/or utterances) or text-based communication (e.g., typed words). Examples of virtual assistants that may implement the conversation manager 103 include Siri® by Apple®, Cortana® by Microsoft®, Alexa® by Amazon.com® and Google Assistant®.

The conversation manager 103 may interpret the user input 108 to determine the report context 110. The user input 108 may be a report generation request made by a user. The report context 110 may include information related to the intent of the user input 108. For example, the conversation manager 103 may determine report objectives that are expressed by the user input 108. A report context 110 may include conditions unique to an interaction session with the conversation manager 103.

In some examples, the conversation manager 103 may interact with the user to clarify the report context 110. For example, if the conversation manager 103 cannot confirm the intent of the user input 108, then the conversation manager 103 may interact (e.g., via sound or text) with the user to determine arguments, variables and/or conditions that define the report context 110.

In some examples, the conversation manager 103 may be hosted at a remote location from the computing device 102. For example, the computing device 102 may connect to the conversation manager 103. The computing device 102 may connect to conversation manager 103 via a network. Examples of networks may include wide area networks (WANs) (e.g., the Internet), local area networks (LANs), metropolitan area networks (MANs), and/or personal area networks (PANs), etc. Networks may be implemented using wired technology (e.g., Ethernet, Data Over Cable Service Interface Specification (DOCSIS), synchronous optical networking (SONET), and/or synchronous digital hierarchy (SDH), etc.) and/or wireless technology (e.g., Institute of Electrical and Electronics Engineers (IEEE) 802.11 (Wi-Fi), IEEE 802.15 (WiMAX), Bluetooth, ZigBee, near-field communication (NFC), and/or Long-Term Evolution (LTE), etc.).

A network may include devices. For example, a network may include computing devices, routers, switches, gateways, access points, and/or modems (not shown in FIG. 1).

In other examples, the conversation manager 103 may be hosted by the computing device 102. For example, the computing device 102 may be a server that hosts the conversation manager 103.

In some examples, the conversation manager 103 may receive the user input 108 from a remote computing device. For example, the conversation manager 103 may receive the user input 108 from a remote desktop computer, mobile computing device or remote web user interface (e.g., web browser) over a network.

Easy and quick access to information is beneficial. Individuals and companies, from all business areas, are producing data, generating information and, increasing the consumption of the produced information. In an example, a device-as-a-service (DaaS) application may be used by a company. A DaaS portal may work on top of data collected by computing devices that is later processed in a remote network location (e.g., in the cloud). In some examples, this information may be made available to device fleet managers and information technology (IT) administrators in the form of multiple reports with valuable data. These reports are one input that may be used to make informed decisions. However, manual report generation may be repetitive, time consuming and cumbersome.

Similar situations occur in many different areas. For example, portals and content management tools may be available to produce reports. Most of the time, such reports are designed, implemented and made available in a predefined and static way. In some cases, there may be an option to filter the results before generating the report. However, these reports are not dynamic in a way that the end user, who is requesting access the information, is the one that defines what is going to display.

Additionally, it is a common practice to use a particular report, apply the available filters and then export the file to proceed with further filtering and adjustments of the report. This additional step usually takes time and blocks the end user (e.g., employee) from focusing on other tasks.

Furthermore, from a security perspective, legacy systems may protect their information using a set of credentials. A user that has the correct credentials may gain access to a particular set of reports. Based on the credential level, a determined number of reports or data might not be available.

The conversation-based report generation with report context described herein may provide information and dynamic reports 112 to a user interactively using a conversation manager 103, thereby simulating a live personal assistant. Communication between the user and the system 100 can be implemented orally and/or by using text-based messages (e.g., similar to a chatbot).

The conversation manager 103 may rely on a set of conversational structures establishing a flexible, adaptive and extensible set of scripts, based on natural language processing. When a user interacts with the conversation manager 103, a session with a given report context 110 may be established. As this session progresses, the conversation manager 103 may ask questions and clarifications to obtain information that facilitates the system 100 to refine and define what is actually requested by the user. Therefore, responses from the user may result in guidance to the conversation manager 103 in such way that the system 100 can chose the best path to follow.

In some examples, the end user may provide user input 108 to the conversation manager 103, which may be ready to answer questions, receive requests and/or execute instructions. With an interaction started, the user can ask questions or make requests of the conversation manager 103. For example, the user may submit a request to the conversation manager 103 for a report 112 to be created. The user may further request that the produced output be customized based on his/her specific needs. The conversation manager 103 may create a report context 110 based on the user input 108.

Once the report context 110 is defined, the conversation manager 103 may provide the report context 110 to the computing device 102. The computing device 102 may generate a report 112 based on the received report context 110. For example, a report generator 104 may engage in the process of obtaining information as instructed by the report context 110. The actual data or action to be generated as the result of this conversational interaction, may be collected from local resources (e.g., files stored on a user's computer), from a local software (e.g., from an e-mail program, or document folder) or remotely (e.g., from a particular database or an external API).

In an example, the report 112 may be generated by organizing and presenting information from a database by using the report context 110. Upon receiving the report context 110, the report generator 104 may query the database according to the report context 110. Upon receiving information from the database, the report generator 104 may format the presentation of the information based on the report context 110. For example, the report generator 104 may apply filters to the database information as requested by the user. The report 112 may be displayed by the computing device 102 or communicated to a remote computing device.

In some examples, the report 112 may be saved as a certain file format for later use. For example, when saving the report 112, the user can assign a name (e.g., “daily metric report”). Then, later, the user may start a new interaction with the system 100 based on the saved report 112. For example, the user may provide the request “generate a new daily metric report for today” or even replace “today” with a previous date, to retrieve historical information.

In some examples, a report 112 may be fully customized, both in terms of data filtering but also on the display and layouts. For instance, in response to the report context 110, the report 112 may be generated based on a report type. The report generator 104 may offer a user a set of distinct layouts for the report 112. For example, the report type may include lists, data tables, summaries, etc. Upon report creation, the user can select which format fits his/her needs best and, based on this decision, the report generator 104 may adapt the produced output.

The customization process may also include the amount of data to be reduced and the actual information that is displayed. This means that the user will be able to filter the report 112 by providing criteria in the user input 108. For example, the user may request that columns or a set of data be dropped (e.g., deleted) that the user is not interested in viewing.

Customization information may be included in the report context 110. For example, the computing device 102 may store the report context 110 provided by the conversation manager 103 in a report context storage 106. As the user interacts with the conversation manager 103, the report customization information may be included in the report context 110 for later use in generating subsequent reports 112.

In some examples, the report context 110 may include formatting information. In addition to customized report creation, additional actions may be accessible through speech commands. For example, the user may request that the content of the report 112 be exported and/or shared in a particular format. Once the desired report 112 is created and made available, the user can request the conversation manager 103 to export to a particular file format (e.g., a spreadsheet format or portable document (PDF) format).

In some examples, the report context 110 may also include sharing information. The user may request that the report 112 be shared (e.g., sent to) with a particular recipient. For example, the user may instruct the conversation manager 103 to email the completed report 112 to a certain email address.

Each time the user engages in a new conversation with the conversation manager 103, a report context 110 may be created and/or modified. A given report context 110 may be associated with a produced report 112. Because each report 112 has a unique report context 110 associated with it, the user can re-use the saved report contexts 110 from a previous conversation to do follow up questions for new reports 112. The multiple report contexts 110 may be saved in the report context storage 106. A user may go back to a generated report 112 and ask follow up questions or apply additional filters without having to re-start the whole report-creation process again.

In some examples, the computing device 102 may provide a user interface element associated with the saved report context(s) 110. The user interface element may be selectable to choose a saved report context 110 for subsequent report generation.

In an example, a user may interact with the conversation manager 103 to generate a first report. A first report context for the first report may be saved by the computing device 102. The user may then request a second report, which may be associated with a second report context. The user may then desire to create a third report based on the first report. The user may select the first report (e.g., select a user interface element associated with the first report) and may interact with the conversation manager 103 to generate the third report. The third report may inherit the first report context. In other words, the third report may start with the first report context. For example, the conversation manager 103 may engage with the user using the first report context. The conversation manager 103 may ask questions of the user to determine the intent of the third report context associated with the third report. The third report context may add to the inherited first report context.

Each produced report 112 may have a unique report context 110 associated with it that provide the requester the ability to recover a report context 110 and ask for follow up. This means that a user can create a given report 112, use the information and later return to the report 112 asking just for a particular filter to be added, using voice or text commands, without having to re-create the whole report 112. The conversation-based report generation with report context described herein provides for easy, quick, secure and highly adaptive access to information presented in a report 112.

With the described conversation-based report generation with report context, the report knowledgebase may be easily increased and the number of reports may be extended to address new objectives of an end user. Additionally, the reports 112 may be presented in multiple formats, based on user needs. By using speech (e.g., voice or text) to create, filter and adjust reports 112, users may customize the produced output while simultaneously reducing the amount of time spent on manual and repetitive tasks.

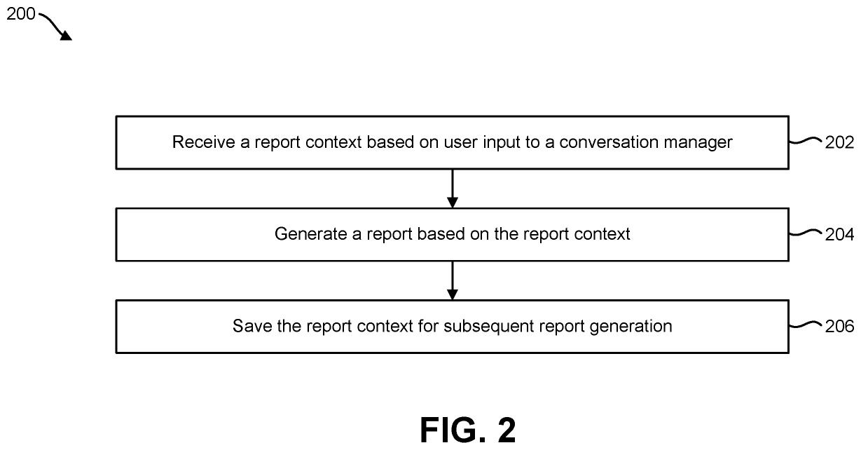

FIG. 2 is an example flow diagram illustrating a method 200 for conversation-based report generation with report context. A computing device 102 may receive 202 a report context 110 based on user input 108 to the conversation manager 103. The report context 110 may include information related to the intent of the user input 108. In some examples, the report context 110 may also include information related to filters applied to a generated report 112. The computing device 102 may receive 202 the report context 110 from the conversation manager 103, which receives the user input 108 in the form of voice or text communication.

The computing device 102 may generate 204 a report 112 based on the report context 110. For example, the computing device 102 may obtain information as instructed by the report context 110. In some examples, report generation may include obtaining and formatting data according to the report context 110. The data may be collected from local resources (e.g., files stored on a user's computer), from a local software (e.g., from an e-mail program, or document folder) or remotely (e.g., from a particular database). In some cases, the computing device 102 may invoke an Application Programming Interface (API) to obtain data for the report 112. The API may be a software intermediary that enables two applications to talk to each other.

In some examples, report generation may include formatting the obtained data according to the report context 110. For instance, the report context 110 may include filters and/or report types that are applied to the report 112.

The computing device 102 may save 206 the report context 110 for subsequent report generation. For example, the computing device 102 may store the report context 110 provided by the conversation manager 103 in a report context storage 106. A user may select the saved report context 110 as the basis for a new report 112. For example, a new report 112 may inherit the saved report context 110. Therefore, a user may go back to a saved report context 110 and begin interacting with the conversation manager 103 (e.g., ask follow up questions or apply additional filters) without having to re-start the whole report creation process again.

Because the report context 110 is saved for later usage, the user may have multiple active reports 112. The user may navigate between active reports 112 and make use of the saved report contexts 110.

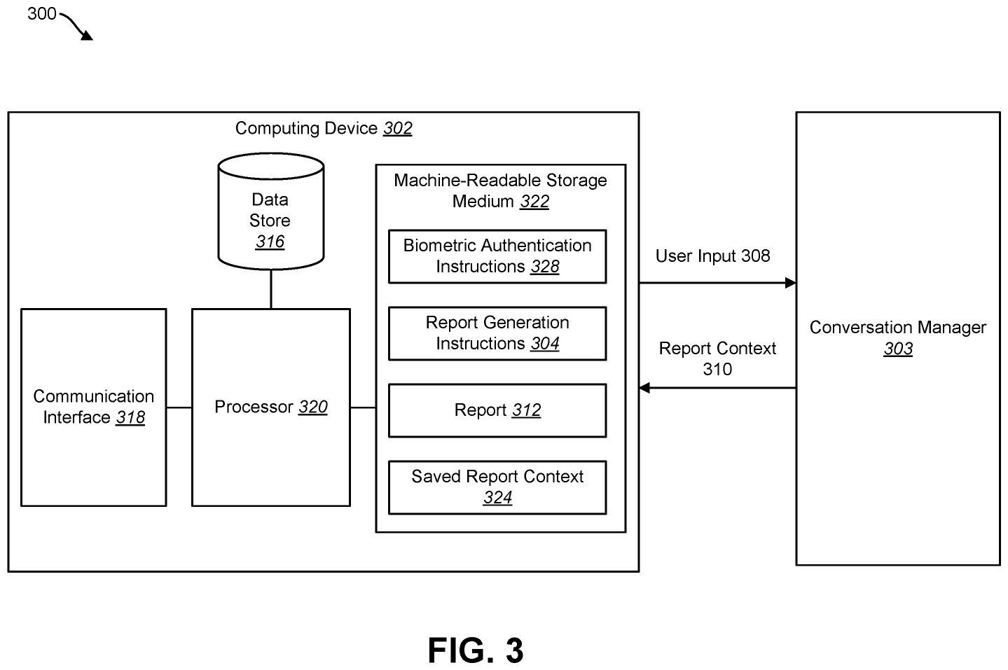

FIG. 3 is another example block diagram of a system 300 in which conversation-based report generation with report context may be performed. The system 300 may include a computing device 302 and a conversation manager 303 that may be examples of the computing device 102 and conversation manager 103 described in connection with FIG. 1.

The computing device 302 may include a processor 320, a data store 316, a machine-readable storage medium 322, and/or a communication interface 318. The computing device 302 may be an example of the computing device 102 described in connection with FIG. 1 in some implementations. For instance, the processor 320 and/or the machine-readable storage medium 322 may implement the conversation-based report generation with report context described in connection with FIG. 1. The computing device 302 may include additional components (not shown) and/or some of the components described herein may be removed and/or modified without departing from the scope of this disclosure.

The processor 320 may be any of a central processing unit (CPU), a semiconductor-based microprocessor, graphics processing unit (GPU), FPGA, an application-specific integrated circuit (ASIC), and/or other hardware device suitable for retrieval and execution of instructions stored in the machine-readable storage medium 322. The processor 320 may fetch, decode, and/or execute instructions (e.g., report generation instructions 304) stored on the machine-readable storage medium 322. Additionally or alternatively, the processor 320 may include electronic circuits that include electronic components for performing functionalities of the instructions (e.g., report generation instructions 304 and/or biometric authentication instructions 328). It should be noted that the processor 320 may be configured to perform any of the functions, operations, steps, methods, etc., described in connection with FIGS. 1-2 and/or 4-6 in some examples.

The machine-readable storage medium 322 may be any electronic, magnetic, optical, or other physical storage device that contains or stores electronic information (e.g., instructions and/or data). Thus, the machine-readable storage medium 322 may be, for example, RAM, EEPROM, a storage device, flash memory, an optical disc, and the like. In some implementations, the machine-readable storage medium 322 may be a non-transitory machine-readable storage medium, where the term “non-transitory” does not encompass transitory propagating signals.

The computing device 302 may also include a data store 316 on which the processor 320 may store information. The data store 316 may be volatile and/or non-volatile memory, such as DRAM, EEPROM, magnetoresistive random-access memory (MRAM), phase change RAM (PCRAM), memristor, flash memory, and the like. In some examples, the machine-readable storage medium 322 may be included in the data store 316. Alternatively, the machine-readable storage medium 322 may be separate from the data store 316. In some approaches, the data store 316 may store similar instructions and/or data as that stored by the machine-readable storage medium 322. For example, the data store 316 may be non-volatile memory and the machine-readable storage medium 322 may be volatile memory.

The computing device 302 may further include a communication interface 318. The computing device 302 (e.g., processor 320) may communicate with external devices (not shown) using the communication interface 318. For example, the computing device 302 may utilize the communication interface 318 to communicate with the conversation manager 303. The communication interface 318 may include hardware and/or machine-readable instructions to enable the processor 320 to communicate with the external device(s). The communication interface 318 may enable a wired or wireless connection to the external device(s). For example, the communication interface 318 may include and/or may be coupled to a network interface card, communication ports, and/or a wireless modem, etc., to communicate with clients and/or servers. The communication interface 318 may be utilized to transmit and/or receive information (e.g., performance data, requests, indicators, lists of available applications, lists of servers, remote desktop connection information, streams, binary information, packets, and/or messages, etc.).

In some implementations, the computing device 302 may communicate with various input and/or output devices, such as a keyboard, a mouse, a display, another apparatus, electronic device, computing device, etc., through which a user may input instructions into the computing device 302.

In some examples, the computing device 302 (e.g., the processor 320 through the communication interface 318) may send user input 308 to the conversation manager 303. In other examples, the conversation manager 303 may receive the user input 308 from a remote computing device. For example, the conversation manager 303 may receive the user input 308 from a remote desktop computer, mobile computing device or remote web user interface (e.g., web browser). The user input 308 may be voice data or text data.

The conversation manager 303 may determine a report context 310 using the user input 308. For example, the conversation manager 303 may extract the intent of the user from a voice communication from a user. The conversation manager 303 may send the report context 310 to the computing device 302 to generate a report 312. For example, the machine-readable storage medium 322 may store report generation instructions 304. The processor 320 may execute the report generation instructions 304 using the report context 310 to generate the report 312.

In some examples, the machine-readable storage medium 322 may store biometric authentication instructions 328. The processor 320 may execute the biometric authentication instructions 328 to authenticate a user. In other words, the processor 320 may authenticate a user in the sense of trusting the origin of the user input 308 based on a biometric feature. The biometric feature may be a voice recognition, face recognition or other biometric authentication.

In some examples, when a particular user creates his/her account in a company system, the user may be invited to create a voice profile. Therefore, users may be identified not only through their credentials, but also using their voice. Because users may interact with the conversation manager 303 using voice, content in a generated report 312 may be provided to authorized personnel using the biometric feature of the voice profile. For example, a user may be asked to read a set of difference utterances. This process will allow the computing device 302 to create a dataset with the user voice profile that can be used for secure report generation. Access to report information may be granted through voice authentication.

It should be noted that other forms of biometric authentication may be implemented. For instance, voice authentication is an example of biometric authentication. However, other forms of biometric authentication (e.g., face recognition/authentication) may also be used to authorize report generation. Additionally, a combination of biometric authentication (e.g., voice and face recognition) may also be used to authorize report generation.

In some examples, when a user provides a voice request to the conversation manager 303, the processor 320 may evaluate the speech from the request (e.g., the report generation request) and may validate the speech against this pre-processed (and trusted) voice dataset. If the voice from the request is a match with the existing voice profile, the report 312 may be generated and displayed. Otherwise, a message may be shown, indicating that the information will not be displayed due to security reasons.

As described in connection with FIG. 1, the processor 320 may generate a report 312 based on the report context 310. The generated report 312 and associated report context 310 may be saved for later usage. In some examples, the generated report 312 may be protected with a voice restriction. For example, a particular report 312 may be created every week with a “save for later usage” feature. The user can then request a new report 312. Using the saved report context 324, the system 300 will know the intent for the new report 312.

In some examples, when saving the report 312, the user may choose to protect the report 312 and/or associated report context 310 using the voice biometric feature. When protected, a report 312 can be linked to one user or multiple users. For example, access to a protected report 312 may be granted to a group of users (e.g., accounting department, engineering department, etc.).

In some examples, target information for the report 312 may be classified and protected in order to restrict (e.g., limit) access. For such cases, the computing device 302 and/or conversation manager 303 may verify the speech of the requester (e.g., user) to ensure that the speech represents a trustable source. The generated report 312 may be provided (e.g., displayed or saved) to authorized users, while unauthorized users will not gain access to the information.

Therefore, the conversation-based report generation with report context described herein may provide dynamic report creation. Additionally, the content of the report 312 may be adjusted and re-executed any number of times, until the original intent is reached. From a security perspective, biometric authentication (e.g., voice biometrics) may provide an additional layer of protection, besides or in addition to traditional credentials.

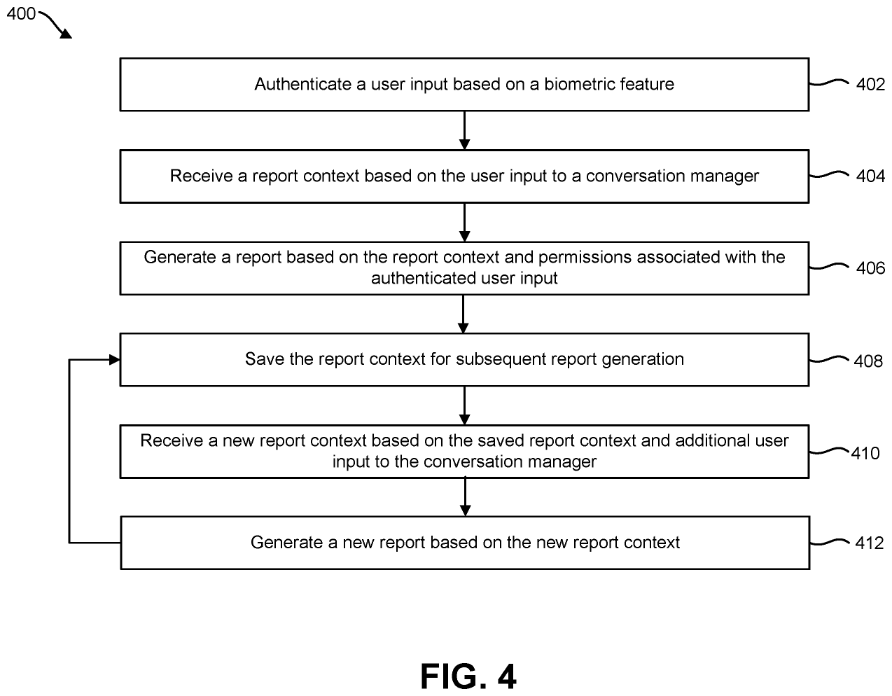

FIG. 4 is an example flow diagram illustrating another method 400 for conversation-based report generation with report context. The computing device 302 may authenticate 402 user input 308 based on a biometric feature. For example, the computing device 302 may receive the user input 308 in the form of a voice communication made to a conversation manager 303. The user input 308 may originate at the computing device 302 or may be provided to the computing device 302 from a remote source. The computing device 302 may evaluate the speech from the user input 308 (e.g., the report generation request) and may validate against a pre-processed (and trusted) voice profile. If the voice from the user input 308 is a match with the existing voice profile, the user input 308 may be authenticated; otherwise, a message may be shown, indicating that the information will not be displayed due to security reasons.

It should be noted that the computing device 302 may authenticate 402 user input 308 based on other biometric features besides, or in addition to, voice recognition. For example, report generation and/or display may be protected with face recognition. In an example, a report 312 that may be protected with a biometric feature and the user may request the report 312 using text (e.g., not voice). For this particular case, the system 300 can reply to the user with a “phrase challenge” that the user must read in order to grant access to the requested report 312 (or, as an alternative, use a secondary biometric authentication, when available).

The computing device 302 may receive 404 a report context 310 based on the user input 308 to the conversation manager 303. For example, the conversation manager 303 may extract the intent of the user input 308. The report context 310 provided by the conversation manager 303 may indicate the extracted intent. The report context 310 may include an action or instruction for generating a report 312. The report context 310 may also include filters for the report 312, customization information, formatting information and/or sharing information for the report 312 as described in connection with FIG. 1.

The computing device 302 may generate 406 a report 312 based on the report context 310. This may be accomplished as described in connection with FIG. 2.

In some examples, the computing device 302 may generate 406 the report 312 based on permissions associated with the authenticated user input 308 and the report context 310. For example, information targeted by the report context 310 may be classified and protected in order to restrict (e.g., limit) access. The computing device 302 may generate 406 the report 312 if the user associated with the user input 308 is authorized to access the information in the report 312. Otherwise, an unauthorized user will not gain access to the information.

In some examples, the user might request a protected report 312 using text. For this particular case, the system 300 may send a challenge phrase to be read by the user to validate the voice. In other examples, the system 300 may use an alternative biometric validation method. In yet other examples, the system 300 may block access to the protected report 312. In this case, the system 300 may inform the user that the requested report 312 may be accessed through voice command. These different validation alternatives may be configured by the system administrator.

The computing device 302 may save 408 the report context 310 for subsequent report generation. This may be accomplished as described in connection with FIG. 2.

The computing device 302 may receive 410 a new (e.g., second) report context 310 based on the saved report context 324 and additional user input 308 to the conversation manager 303. For example, the computing device 302 may provide a user interface element associated with the saved report context 324. The user interface element may be selectable to choose the saved report context 324 for subsequent report generation. If a user selects the user interface element, then the computing device 302 may start a new report 312 that inherits the saved report context 324. In some examples, the computing device 302 may communicate the selected saved report context 324 to the conversation manager 303.

The conversation manager 303 may create the new report context 310 using first report context 310 (or other prior report context 310) as a basis for the additional user input 308. For example, the conversation manager 303 may interpret the additional user input 308 using the saved report context 324 as a reference point. Therefore, even if the user starts the new report 312 after ending the conversation for the first report 312, the conversation manager 303 may know what the user is talking about. The conversation manager 303 may send the new report context 310 to the computing device 302.

The computing device 302 may generate 412 a new (e.g., second) report 312 based on the new report context 310. For example, the computing device 302 may generate the new report 312 according to instructions included in the new report context 310. The computing device 302 may save 408 the new report context 310 for subsequent report generation.

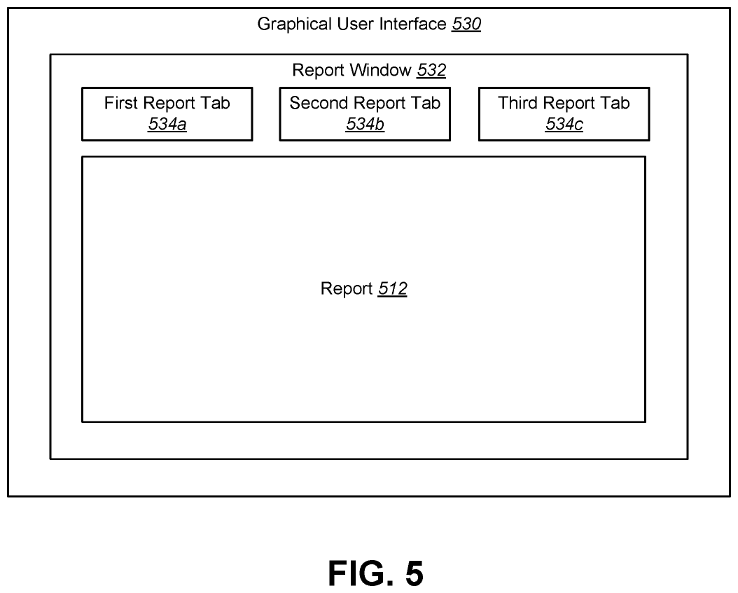

FIG. 5 is an example of a graphical user interface (GUI) 530 for conversation-based report generation with report context. The GUI 530 may be generated by a computing device (e.g., computing device 102 and/or computing device 302) to display a report 512. The GUI 530 may be displayed at the computing device or at a remote computing device (e.g., remote desktop computer, mobile computing device or remote web user interface).

In some examples, the GUI 530 may include a report window 532. One report 512 or multiple reports 512 may be displayed within the report window 532. The report(s) 512 may be generated as described in connection with FIGS. 1-4. For example, a user may communicate with a conversation manager, which generates a report context 110. The computing device may generate the report 512 using the report context. The computing device may save the report 512 and associated report context 110.

The GUI 530 may provide a user interface element associated with the saved report context. The user interface element may be selectable to choose the saved report context 110 and report 512 for subsequent report generation.

In this example, the report window 532 includes three selectable report tabs 534, which are examples of user interface elements. A first report tab 534a may be associated with a first report 512. A second report tab 534b may be associated with a second report 512. A third report tab 534c may be associated with a third report 512.

Upon selecting a report tab 534, the associated report 512 may be displayed. Additionally, the report context 110 associated with the selected report tab 534 may be selected for subsequent report generation via user input 108 to the conversation manager 103. For example, if a user selects the first report tab 534a, then the report context 110 for the first report may be loaded into the conversation manager 103, which may interpret subsequent user input 108 according to the first report context 110.

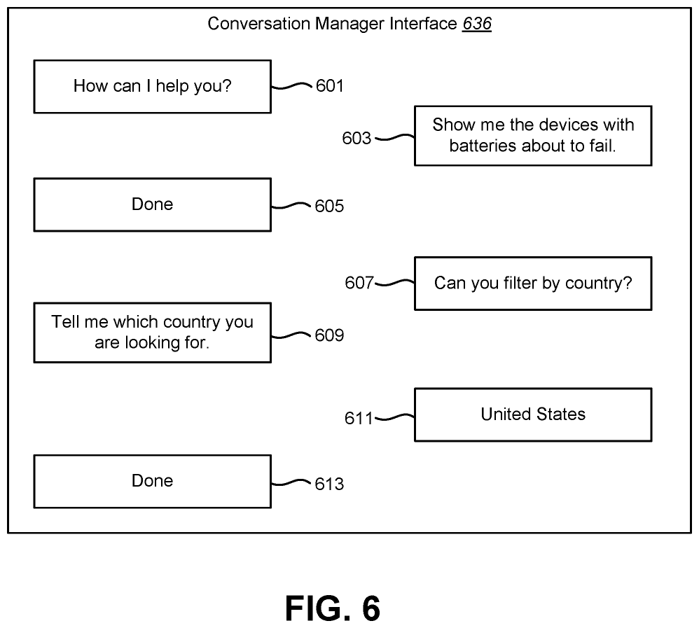

FIG. 6 is an example of a conversation manager interface 636 for conversation-based report generation with report context. The conversation manager interface 636 may be generated by a computing device (e.g., computing device 102 and/or computing device 302) and/or a conversation manager to display communications between a user and the conversation manager. In some examples, the conversation manager interface 636 may be included in a DaaS portal.

An example of a conversation between a conversation manager and a user is illustrated in FIG. 6. Messages from the conversation manager are displayed on the left side of the conversation manager interface 636. Messages from the user are displayed on the right side of the conversation manager interface 636. The user input may be in the form of voice (e.g., captured by a microphone) or in the form of a text message (e.g., typed into a keyboard or keypad). In this example, the voice is transcribed to text and added to the conversation manager interface 636. Also, the response from the conversation manager may be communicated to the user as a synthetized voice, which is also transcribed as text in the conversation manager interface 636.

In a first message 601, the conversation manager asks “How can I help you?” when the user initiates the conversation manager. In a second message 603, the user responds “Show me the devices with batteries about to fail.” The conversation manager receives this user input and generates a report context 110 from which a report 112 may be generated. In some examples, the report 112 may be displayed, exported and/or shared according to the current of saved report context 110. The conversation manager indicates that the report 112 has been generated in the third message 605 that says “Done.”

At a later time, the user may ask in the fourth message 607 “Can you filter by country?” The conversation manager may start the process of creating a second report 112 that inherits the report context 110 of the first report 112. It should be noted that the conversation manager knows that the user is asking about devices with batteries about to fail because of the first report context 110 that was saved. However, in this case, the conversation manager does not have sufficient information to create the second report context 110. In other words, the conversation manager does not know which countries to filter. Therefore, the conversation manager asks in the fifth message 609 “Tell me which country you are looking for.” The user responds to this request in sixth message 611 with “United States.”

Having sufficient information from the user, the conversation manager may generate the second report context 110, which is sent to the computing device 102 to generate the second report 112. The conversation manager indicates that the second report 112 has been generated in the seventh message 613 that says “Done.”

In another example (not shown), a database may store information about a fleet of computers. The user may ask the conversation manager to generate a first report on the grade of a fleet of computers. In this case, the report context 110 includes the grade of the computer fleet. The user may ask the conversation manager to further filter the report based on computer models and location. In this case, the first report context may be used to generate a second report from the database that filters certain computer models that are located in a particular country (e.g., United States).

Continuing this example, at a later time, the user may select the first report and ask the conversation manager to generate a report for devices with batteries about to fail next week. In this case, the conversation manager knows from the first report context that the user is asking about the computer fleet. The conversation manager may generate a third report context 110 that includes devices in the computer fleet with batteries about to fail next week. A third report 112 may be generated from the database using this third report context 110 to filter devices in the computer fleet with batteries about to fail next week.

1. A method for report generation, comprising:
receiving a report context based on user input to a conversation manager;
generating a report based on the report context; and
saving the report context for subsequent report generation.

2. The method of claim 1, wherein the report context comprises information related to an intent of the user input.

3. The method of claim 1, wherein the report context further comprises information related to filters applied to the generated report.

4. The method of claim 1, further comprising receiving a second report context based on the saved report context and additional user input to the conversation manager.

5. The method of claim 1, further comprising generating a second report based on the saved report context, wherein the second report inherits the saved report context.

6. The method of claim 1, further comprising providing a user interface element associated with the saved report context, wherein the user interface element is selectable to choose the saved report context for subsequent report generation.

7. The method of claim 1, further comprising:
authenticating the user input based on a biometric feature; and
generating the report based on permissions associated with the authenticated user input and the report context.

8. A computing device for report generation, comprising:
a memory;
a processor coupled to the memory, wherein the processor is to:
receive a report context based on user input to a conversation manager;
generate a report based on the report context; and
save the report context for subsequent report generation.

9. The computing device of claim 8, wherein the report context comprises information related to an intent of the user input.

10. The computing device of claim 8, wherein the report context further comprises information related to filters applied to the generated report.

11. The computing device of claim 8, wherein the processor is to receive a second report context based on the saved report context and additional user input to the conversation manager.

12. The computing device of claim 8, wherein the processor is to generate a second report based on the saved report context, wherein the second report inherits the saved report context.

13. The computing device of claim 8, wherein the processor is to provide a user interface element associated with the saved report context, wherein the user interface element is selectable to choose the saved report context for subsequent report generation.

14. The computing device of claim 8, wherein the processor is to:
authenticate the user input based on a biometric feature; and
generate the report based on permissions associated with the authenticated user input and the report context.

15. A non-transitory machine-readable storage medium encoded with instructions executable by a processor, the machine-readable storage medium comprising:
instructions to receive a report context based on user input to a conversation manager;
instructions to generate a report based on the report context; and
instructions to save the report context for subsequent report generation.
